(19) United States
(12) Patent Application Publication
(10) Pub. No.: US 2011/0120219 A1
(43) Pub. Date: May 26, 2011

(54) CAPACITIVE LIQUID LEVEL SENSOR

(75) Inventors: Lorenzo Barlesi, Charleroi (BE); Michel Chiaffi, Breuil Le Vert (FR); Volodia Naydenov, Louvain-la-Neuve (BE)

(73) Assignee: INERGY AUTO. SYSTEMS RESEARCH (SOCIETE ANONYME), BRUSSELS (BE)

(21) Appl. No.: 11/722,405

(22) PCT Filed: Dec. 20, 2005
(86) PCT No.: PCT/EP2005/056967

§ 371 Date: Nov. 12, 2009

(30) Foreign Application Priority Data
Dec. 22, 2004 (EP) 04106867.7

(51) Int. Cl. G01F 23/26

(52) U.S. Cl. 73/304 C

(57) ABSTRACT

The invention relates to a capacitive sensor (2) for detecting the level (52) of a liquid (54) in a tank (48). The inventive sensor consists of: a flat longitudinal support (4) comprising proximal (8), central (10) and distal (12) parts and connection means (6) which are located in the proximal part (8) and which are used to connect the support (4) and the exterior of the support (4) electrically; a measuring pair (14) comprising interdigital arms which are disposed on the support (4) at least in the central part (10) thereof; and a reference pair (16) comprising interdigital arms which are disposed on the support (4) in the distal part (12) thereof. The aforementioned support (4) comprises at least three layers, and the reference pair (16) is linked to at least one connection track (26) which is located in an inner layer (24) of the support (4) and which is linked to the above-mentioned connection means (6). The invention also relates to a tank (48) comprising one such sensor (2).

### FIELD OF THE INVENTION

The invention relates to a capacitive sensor for the liquid level of a tank, including a longitudinal and substantially flat support, intended to be positioned in the tank, the support including a proximal part, a central part and a distal part; and connection means, located in the proximal part, to electrically connect the support and the outside of the support; a first pair of electrodes, known as a measurement pair, including arms that are interdigital and positioned on the support, at least in its central part; and a second pair of electrodes, known as a reference pair, including arms that are interdigital and positioned on the support in its distal part.

The invention relates, in addition, to a tank including such a sensor.

### PRIOR ART

Such capacitive sensors are already known in the prior art.

For example, U.S. Pat. No. 4,296,630 describes an apparatus for measuring the level of a fluid in a container by the use, on a stripline, of measurement electrodes forming a measuring condenser and compensation electrodes forming a compensation condenser, thanks to which the effect of the variable dielectric constant of the medium on the measuring result can be compensated for thanks to an evaluation circuit. In this apparatus of the prior art, the measurement electrodes and the compensation electrodes are arranged on an oblong common line so that the compensation electrodes are located near at least one suction channel for the medium and the measurement electrodes are located in the medium.

The presence of measurement electrodes alone is not, in effect, sufficient to produce a capacitive sensor which may supply a signal from which the liquid level can be directly derived, when the dielectric constant of the liquid is not a priori known or when it is variable, due to variations in its temperature or its composition for example. It is necessary to position additional electrodes, known as reference or compensation electrodes, preferably in the bottom of the tank containing the liquid, so as to be able to continuously obtain a measurement of the liquid level that is independent but that is a function of its dielectric constant.

This type of compensation capacitive sensor, known in the prior art, and of which the electrodes are positioned at the surface of a flat longitudinal support of the stripline type so that the electric field at the electrode terminals is mainly influenced by the liquid, is effective for compensating, in real time, for the changes in the dielectric properties of the liquid of which the level has to be measured, while being relatively inexpensive. This type of sensor also has a relative robustness due to its simple production, which is generally in one piece, in comparison with capacitive sensors having flat parallel plates or having coaxial cylindrical electrodes, which require a complex arrangement of plates or electrodes and spacers which could upset the measurement.

In addition, this type of sensor does not require any moving parts, unlike for example certain float sensors from the prior art. The latter sensors are often less robust due to the presence of moving parts, subject to wear and impacts.

Despite their advantages, the capacitive sensors of the prior art do not however offer sufficient precision for certain applications especially because the signal supplied by the reference electrodes is, in the art, significantly influenced by the level of the liquid. This undesirable influence is due to the configuration of the sensors of the prior art in which the reference electrode supply line is often long, positioned along the measurement electrodes and thus forms an additional capacitance.

### SUMMARY OF THE INVENTION

One object of the invention is to provide a capacitive sensor offering a better measurement precision at an equal manufacturing cost. Moreover, an additional object of the invention is to provide a more compact sensor.

For this purpose, the sensor according to the invention is characterized in that the support includes at least three layers; and the reference pair is linked to at least one connection line located in an inner layer of the support and linked to the connection means.

The sensor according to the invention solves, in an original manner, the problem of the undesirable influence of the connection line running from the reference electrodes to the connection means on the signal obtained by the reference pair. This is because the sensors of the prior art either do nothing to overcome this undesirable influence, or they use a guard ring, such as for example the device from French Patent Application FR 2 647 898, or earthing strips, such as for example in the sensor from International Application WO 99/10714 (which certainly improves the precision of the level measurement, but does not sufficiently suppress the influence of background electric fields and again creates a measurement error that is not insignificant), or else complex line arrangements or structures combined with suitable electronic compensation systems.

The sensor according to the invention includes a connection line which is not located on the surface where the electrode arms are located, but in an inner layer of the support, owing to the use of a longitudinal, substantially flat and multilayer support. In this way, the connection line is not directly next to the liquid and is sufficiently isolated from the part of the tank where the variation of the liquid level is measured, and the capacitance measured at the terminals of the reference pair is dependent on the dielectric constant of the liquid, and substantially independent of its level, when the reference pair is of course completely immersed.

In other words, a spatial separation is made between the operational lines of the reference pair, which enables the capacitive measurement of the dielectric constant of the liquid, and the connection line, which enables the supply of the reference pair and the transmission of the signal, in the sense that the latter line is not placed on the surface where the first lines are located.

Owing to the insulation of the connection line itself within the multilayer support, the precision of the measurement of the dielectric constant of the liquid is better for a constant cost, and the measurement of the liquid level is also more precise for a constant manufacturing cost.

Moreover and as an additional advantage, the surface which is occupied by the connection line in a sensor of the prior art, such as that disclosed in the U.S. Pat. No. 4,296,630, is in a certain manner released over the support of the sensor according to the invention and may be used especially in this either to reduce the size of the support and therefore its cost, or to increase the number of interdigital arms of the measurement pair and thus to increase the precision of the measurement.

It should be noted that the proximal part, the central part and the distal part of the support of the sensor according to the invention may be, according to a first embodiment, respectively intended to be placed in a top part, a central part and a bottom part of the tank, or, according to a second embodiment, respectively intended to be placed in a bottom part, a central part and a top part of the tank. According to the first embodiment, the reference pair is thus positioned in the bottom part of the support, and, according to the second embodiment, the reference pair is on the other hand positioned in the top part of the support. In the sensor according to the latter embodiment, the reference pair is used not to measure the dielectric constant of the liquid, but for example to measure the dielectric constant of the gas or of the air above the liquid, or to generate a warning signal on passing a given liquid level, for safety reasons.

According to these two embodiments of the sensor according to the invention, the connection line linking the connection means to the reference pair passes through an inner layer of the support in its central part.

Another object of the invention is to provide a level sensor as described above, intended to produce a measurement that is not very sensitive or insensitive to the variations of the dielectric properties of the material or materials forming the support.

For this purpose, according to one particular embodiment of the invention, the inner layer of the sensor includes at least one earth line, separated from the connection line by a first dielectric, intended to form an additional capacitance so as to compensate, at least partially, for variations in the dielectric constant of the materials forming the support.

During operation, the dielectric constant of the material or materials forming the support varies or is capable of varying depending on the temperature. This variation may significantly corrupt the capacitance measurement obtained at the terminals of the measurement pair, as some of the electric field formed at the terminals of this pair passes through the support. There is therefore a need to know the manner according to which the capacitance at the terminals of the measurement pair varies depending on the temperature in particular, so as to compensate for these variations.

The sensor according to the particular embodiment of the invention has at least one earth line, positioned, for example, in an inner layer of the support. By measuring the capacitance formed between one of the electrodes of the measurement pair and this earth line, it is possible to detect over time the variations in the dielectric constant of the material forming the support. It is thus possible to take into account these variations of the dielectric constant, and of the corresponding structure capacitance, in order to compensate for the measurement of the capacitance formed at the terminals of the measurement pair and finally to obtain a more precise measurement of the liquid level.

Another object of the invention is to provide a sensor as described above, of which the arms of the measurement pair are substantially protected against oxidation and are not dependent on possible conductive particles or conglomerates of conductive particles, stemming from impurities of the liquid, capable of being inserted between two adjacent electrode arms, of short-circuiting the electrodes of the measurement pair and of making the production of a precise capacitance and level measurement decidedly more difficult or even impossible.

For this purpose, according to one particular embodiment of the invention, the sensor is in which the arms of the measurement pair are covered with a protective layer, for example composed of one or more components of polymer resin or lacquer type, preferably inert with respect to the liquid, and in that the inner layer includes an additional line parallel to the connection line and separated from this by a second dielectric of a similar type to that used for the protective layer, intended to form an additional capacitance so as to compensate, at least partially, for variations in the dielectric constant of the materials fowling the protective layer.

In this manner, the capacitance between the connection line and the additional line may be calculated and the variations over time of this capacitance, which is representative of the variations as a function of the temperature and over time of the dielectric constant of the materials forming the protective layer, may be properly taken into account to compensate for the measurement of the capacitance formed at the terminals of the measurement pair, and to obtain a more precise measurement of the liquid level. This taking into account and this compensation are possible because the reasoning behind this realization comes down to adding an equation and an extra unknown, the dielectric constant of the materials forming the protective layer, to the system of equations which may be implicitly or explicitly solved in the sensor according to the invention.

The invention also relates to a tank including such a sensor, for example a fuel tank for an automotive vehicle, a field of application subjected to very demanding accuracy and cost constraints.

### BRIEF DESCRIPTION OF THE FIGURES

These aspects and also other aspects of the invention will be clarified in the detailed description of particular embodiments of the invention, with reference being made to the drawings of the figures, in which:

FIG. 1 shows a schematic view of a particular embodiment of the sensor according to the invention;

FIGS. 2 to 4 show schematic views of other particular embodiments of the sensor according to the invention;

FIG. 5 shows a transverse cross-sectional view of the central part of the support for one particular embodiment of the sensor according to the invention;

FIG. 6 shows a transverse cross-sectional view of the central part of the support for one particular embodiment of the sensor according to the invention, in which the electrodes are present on both sides of the support;

FIGS. 7 and 8 show transverse cross-sectional views of the central part of the support for two particular embodiments of the sensor according to the invention;

FIG. 9 shows an equivalent electronic circuit to illustrate the operation of one particular embodiment of the sensor according to the invention;

FIG. 10 shows a transverse cross-sectional view of the central part of the support for one particular embodiment of the sensor according to the invention, in which a protective layer is especially included and a system for compensating for the capacitance effect of this;

FIGS. 11 to 13 show schematic views of three other particular embodiments of the sensor according to the invention;

FIGS. 14 and 15 show schematic cross-sectional views of two particular embodiments of the tank according to the invention;

FIGS. 16 and 17 show schematic side views of two particular embodiments of the sensor according to the invention; and

FIG. 18 shows a schematic cross-sectional view of another particular embodiment of the sensor according to the invention.

The figures are not drawn to scale. Generally, similar components are denoted by similar references in the figures.

### DETAILED DESCRIPTION OF PARTICULAR EMBODIMENTS

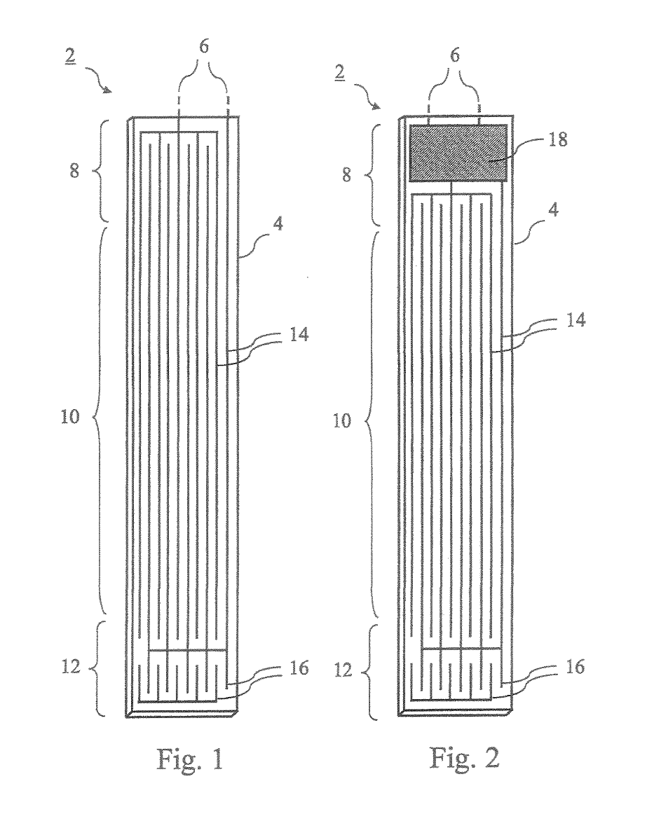

FIG. 1 shows a schematic view of one particular embodiment of the sensor 2 according to the invention, on which the presence of electrodes on a support 4 of the sensor 2 is illustrated. Two pairs of electrodes are represented on the support, these two pairs having one electrode in common. The three electrodes are each composed of parallel aims together forming interdigitated or interleaved combs. The measurement pair 14 is placed in the proximal 8 and central 10 parts of the support 4 and the reference pair 16 is placed in the distal part 12.

One of the two electrodes of the reference pair 16, and more specifically the electrode that is not common to the measurement pair 14, is linked to the connection means 6 by a connection line 26 that is not shown, and is located in an inner layer 24 of the support 4. This connection line 26, or supply line, is linked to the reference pair 16 by a connection passing through the insulating layer 20.

The reference pair 16 is intended, during operation, to be located under the measurement pair 14 and to be completely submerged in the liquid 54 of the tank 48. The measurement is only considered to be valid when this reference pair 16 is completely submerged.

In the particular embodiment illustrated in FIG. 1, the height of the reference pair 16 is considerably lower than that of the measurement pair 14. This enables the level 52 of the liquid 54 to be measured over a significant working height.

Still in the particular embodiment illustrated in FIG. 1, the arms of the measurement pair 14 are oriented in the length direction of the support 4. This arrangement has the advantage of offering a continuous variation of the capacitance at the terminals of the measurement pair 14 in response to a variation of the level 52 of the liquid 54 in the tank 48, at least especially when the support 4 is positioned vertically in the tank 48, that is to say when the proximal part 8 is positioned in the top of the tank 48 and the distal part 12 in the bottom of the tank 48. A measurement pair 14 having arms oriented in the width direction of the support 4 would generate a relationship, between the capacitance at the terminals of the pair 14 and the level 52 of the liquid 54 which would be significantly less linear, and more precisely having jerks.

Moreover, the vertical arrangement of the arms of the two pairs enables a uniformity of manufacture, as they can be manufactured together at the same time and on the same support 4. A substantial similarity in the features and geometry of the electrodes and of the dielectrics between them is thus observed. This homogeneity contributes to the improvement in the accuracy.

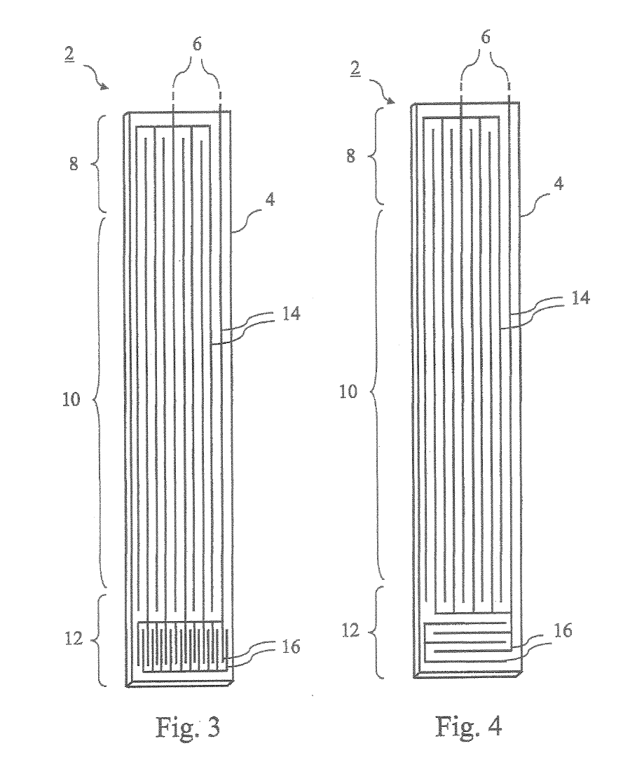

FIG. 2 shows a schematic view of another particular embodiment of the sensor 2 according to the invention, similar to the particular embodiment illustrated in FIG. 1, but comprising, in addition, an electronic evaluation circuit 18 positioned on the support 4. The objective of the electronic evaluation circuit 18 is especially to produce, by combining the capacitance value obtained at the terminals of the measurement pair 14 and that obtained at the terminals of the reference pair 16, the electronic compensation of the variations in the dielectric constant of the liquid 54.

Positioning the electronic circuit 18 outside of the tank 48 constitutes a particular embodiment of the sensor 2 according to the invention, represented in FIG. 1. However, the quality of the signals obtained at the terminals of the electrode pairs 14, 16 is better when this circuit 18 is on the support 4 itself, as shown in FIG. 2. Indeed, the closer the electrode pairs 14, 16 are to the signal-processing device, analogue at the source, the less the signal is corrupted and the more accurate the measurement is.

Once the electronic processing is carried out in the evaluation circuit 18, the analogue signal is converted, according to a particular mode of the invention, into a digital signal whose quality is significantly less sensitive to transport. According to another particular embodiment, the analogue signal is converted into another analogue signal, of which the sensitivity may advantageously be low, by a judicious choice of the properties of this signal, in particular its amplitude.

FIG. 3 shows a schematic view of another particular embodiment of the sensor 2 according to the invention, similar to the particular embodiment illustrated in FIG. 1, but in which the adjacent anus of the reference pair 16 are separated from one another by a shorter distance than the distance separating the adjacent arms of the measurement pair 14 from one another. This arrangement has the advantage of increasing the capacity at the terminals of the reference pair 16 without increasing the external dimensions of the part of the sensor 2 where the reference pair 16 is positioned. Thus, the parasitic capacitances are lower in relative value with respect to the capacitance obtained at the terminals of the reference pair 16, which leads to a better measurement accuracy.

According to one particular embodiment of the invention, the arms of the reference pair 16 are positioned across the support 4, as illustrated in FIG. 4.

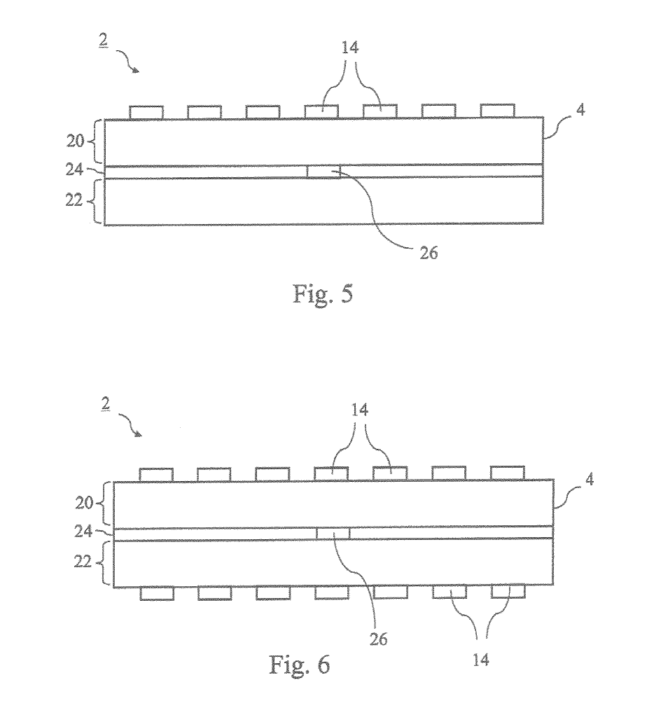

FIG. 5 shows a transverse cross-sectional view of the support 4 for one particular embodiment of the sensor 2 according to the invention. The cross section is taken across the support 4 in its central part 10, that is to say that the arms of the electrodes shown on the surface are the arms of the measurement pair 14. The support 4 shown includes three layers including a first insulating layer 20, positioned on which are the measurement pair 14 and the reference pair 16 (the latter are not visible in this part of the support 4), a second insulating layer 22 and the inner layer 24, located between the first insulating layer 20 and the second insulating layer 22.

The aims of the electrode pairs may for example be 70 microns high by 200 microns wide, which makes it possible to obtain a “plane capacitor” effect that is greater than the edge effects, which however also play a role.

The connection line 26 is located in the inner layer 24 of the support 4 and is in this way physically insulated from the liquid 54.

The insulating layers 20 and 22 are made of a non-conductive substrate. The inner layer 24 is also made of a dielectric material, at least around the conductive connection line 26. In this way, the insulated connection line 26 does not generate additional capacitance that is significantly dependent on the level 52 of the liquid 54. The connection line 26 may generate a slight additional parasitic capacitance, but this is negligible compared with the capacitance at the terminals of the reference pair 16. It is nevertheless important that the distance separating the connection line 26 from the side edge of the support 4 be sufficiently large so that the influence of the electric field passing through the liquid be negligible. The connection line 26 may, for example, be positioned at an equal, or approximately equal, distance from the two side edges of the support 4.

As a further example, for a voltage of 5 volts applied both to the terminals of the measurement pair 14 and to the terminals of the reference pair 16, it is observed that a distance of 400 micrometres is sufficient to avoid a significant background effect of the electric field on the measurement.

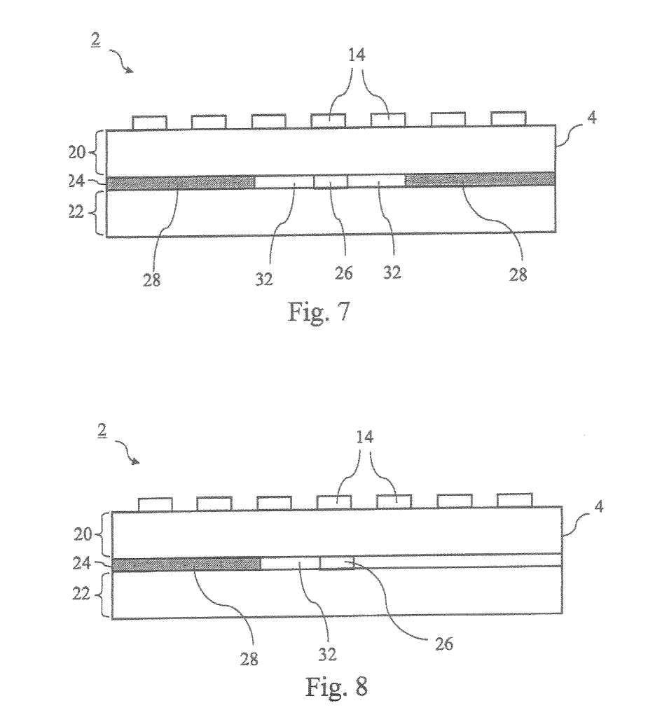

FIG. 6 shows a transverse cross-sectional view of the support 4 for another particular embodiment of the sensor 2 according to the invention. In this, the two pairs of electrodes are divided in two between the two sides of the support 4 so as to increase the capacitances measured and thus increase the sensitivity of the sensor 2, by relative reduction of the parasitic capacitances. According to one particular embodiment of the sensor 2 according to the invention, the respective divided electrode pairs are reconnected before reaching the connection means 6 or the electronic evaluation circuit 18.

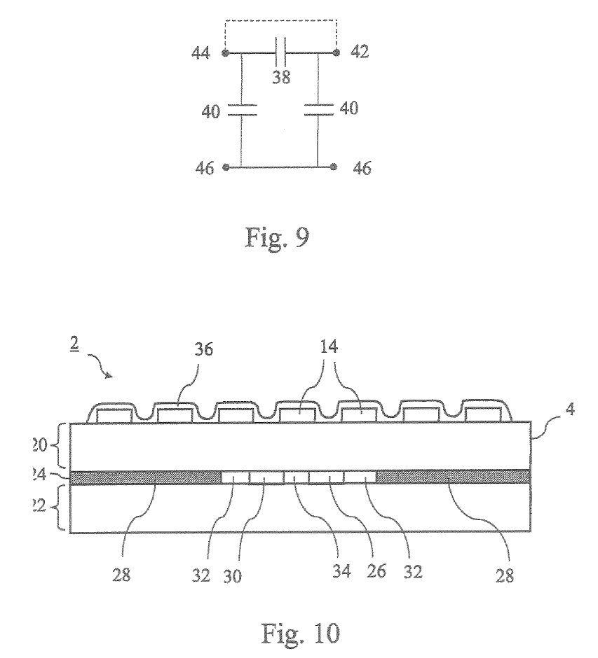

FIGS. 7 and 8 show transverse cross-sectional views of the support 4 for two particular embodiments of the sensor 2 according to the invention, in which either one or two earth lines 28 are present in the inner layer 24, respectively either on one side of the connection line 26, or on both sides of the connection line 26. As explained above, this arrangement makes it possible to produce a compensation of the variations in the dielectric constant of the material or materials forming the support 4. The first dielectric 32 may, for example, be of the same type as the material forming the electrically insulating layer 20 or the insulating layer 22.

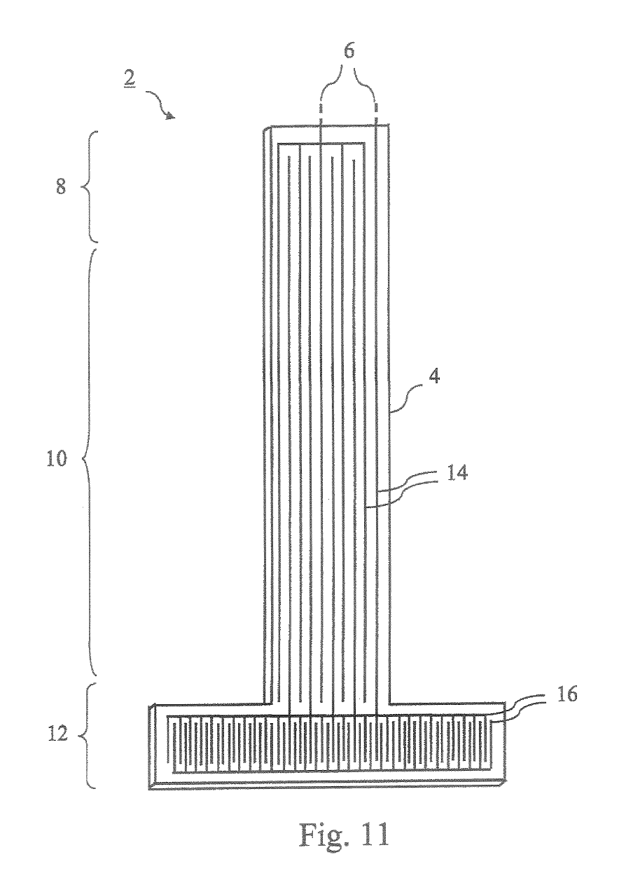

FIG. 9 shows an equivalent circuit that is simplified in order to illustrate how it is possible to measure the influence of the dielectric forming the insulating layer 20, on which the arms of the measurement pair 14 are positioned.

The capacitance 38 represents the capacitance formed by the two electrodes of the measurement pair 14. The terminal 42 corresponds to the terminal of the first electrode of the measurement pair 14, this terminal 42 being, for example, the common terminal 42 known as COM, common to the measurement pair 14 and to the reference pair 16. The terminal 44 corresponds to the terminal of the second electrode of the measurement pair 14, this terminal 44 being, for example, the measurement terminal known as CMES, specific to the measurement pair 14. Measurement of the capacitance between the terminals 42 and 44 makes it possible to calculate the capacitance at the terminals of the main pair, either the measurement pair 14 or the reference pair 16.

The two terminals 46 correspond to the earth lines 28. By short-circuiting the terminals 42 and 44, that is to say the two electrodes of the measurement pair 14, it is possible to measure the capacitance 40, known as the structure capacitance, which mainly depends on the dielectric constant of the material or materials forming the insulating layer 20. The knowledge of this capacitance may be taken into account to compensate for the influence of dielectric variations on the measurement of the main capacitance.

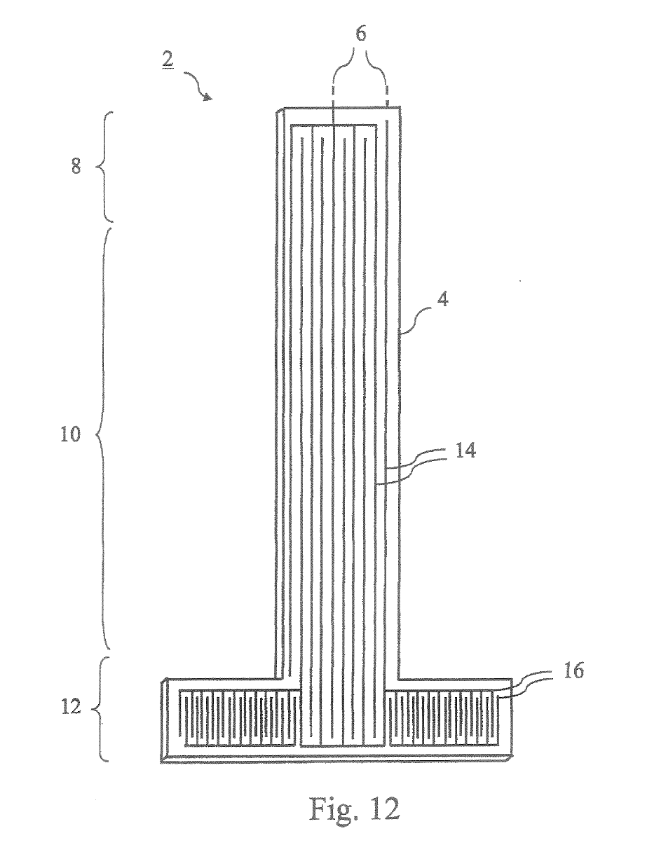

FIG. 10 shows a transverse cross-sectional view of the support 4 for one particular embodiment of the sensor 2 according to the invention, in which a protective layer 14 is present with a system for compensating for the capacitive effect of the latter. An additional line 30 is present in the inner layer 24, parallel to the connection line 26. These two lines 26, 30 are separated by a second dielectric 34, of the same type as the material forming the protective layer 36.

The measurement of the capacitance at the terminals of the connection line 26 and of the additional line 30 therefore make it possible to measure the variations in this capacitance, and the variations over time of the dielectric constant of the material or materials forming the protective layer 36. This measurement may then be transferred into the compensation during the calculation of the level 52 of the liquid 54.

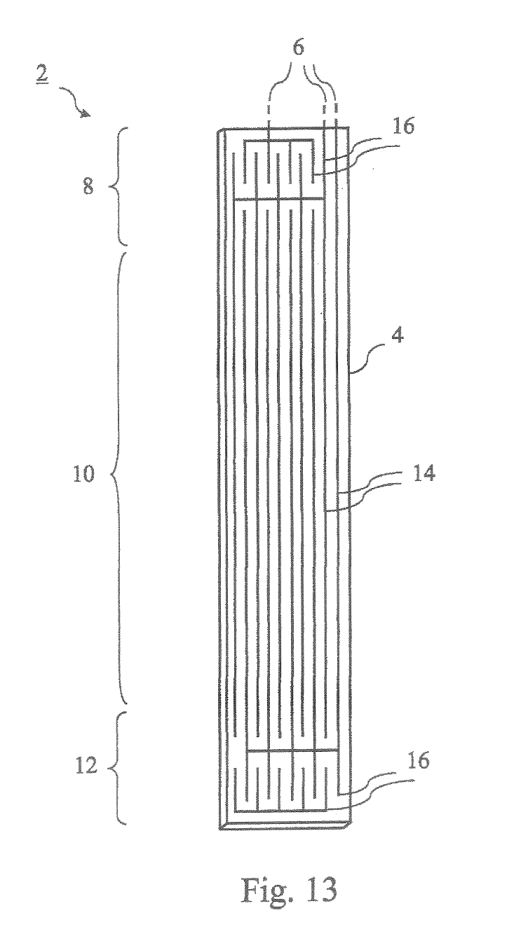

FIG. 11 shows a schematic view of another particular embodiment of the sensor 2 according to the invention, in which the distal part 12 is wider than the central part 10. In this particular embodiment, the width over which the reference pair extends is larger. According to the design of the sensor, the surface area reserved for the reference pair 16 may then be larger, and hence have a better sensitivity, or the height of this surface may be smaller while having a constant surface area, in order to stay in the liquid 54 having a level 52 that is lower.

FIG. 12 shows a schematic view of another particular embodiment of the sensor 2 according to the invention, in which the measurement pair 14 is placed at least in the central 10 and distal 12 parts; and the reference pair 16 is placed on both sides of the measurement pair 14. The sensor 2 according to this particular embodiment has the advantage of enabling measurement over the entire height of the tank 48, even for very low values of the level 52. It should nevertheless be noted that in this case the value of the level 52 is not compensated for or correctly compensated for when the level 52 of the liquid 54 does not completely cover the reference pair 16. However, the absence of compensation for low values of the level 52 is not very detrimental in many types of applications, in which, for very low levels, it is often possible to be satisfied with a less accurate measurement.

FIG. 13 shows a schematic view of another particular embodiment of the sensor 2 according to the invention, in which the support 4 includes an additional reference pair 16 in the proximal part 8. During operation, the additional reference pair 16 is always outside of the liquid 54, in particular above this liquid, whereas the first reference pair 16 is permanently submerged. This particular embodiment has two advantages.

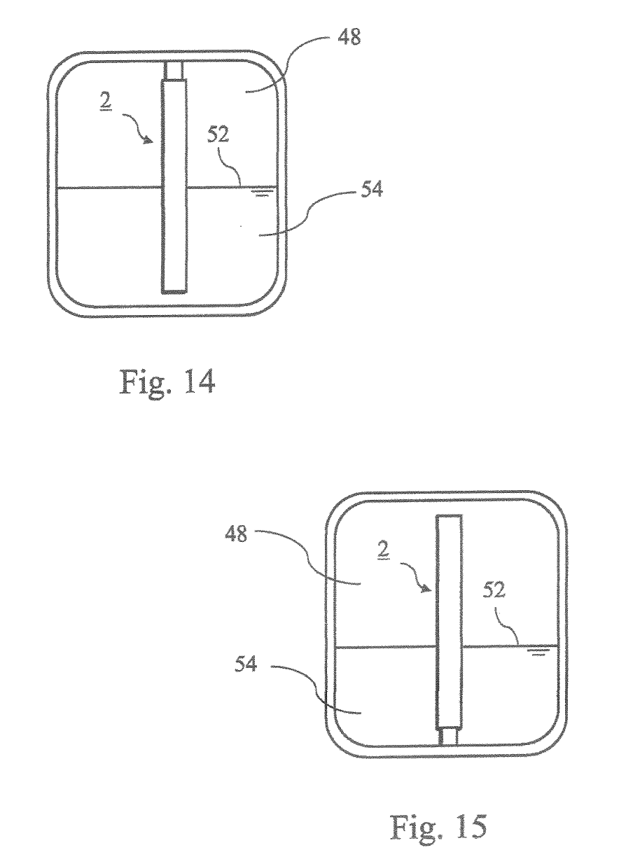

The first is the possibility that the sensor 2 be used for a measurement with connection means 6 at the top of the tank 48, as shown in FIG. 14, or at the bottom, as shown in FIG. 15, the attachment of the sensor 2 being in the latter case underneath (represented in FIG. 15) or/and above the sensor 2 (not shown). Introducing the sensor 2 underneath the tank 48 is possible by a choice corresponding to the arrangement of FIG. 15 for example.

The second advantage is a possibility of increasing the safety in the case of a tank 48 holding fuel transported by a vehicle for example, by making it possible to detect overturning of a vehicle, and thus by making it possible to set in motion the closure of the valves of the tank 48 holding fuel 54, which is critical in the case of an LPG fuel for example. According to one embodiment, during operation and when an unusual capacitance value is detected on the additional reference pair 16, a signal is emitted for activating the solenoid valve for sealing the LPG system, which thus makes it possible to cut off any flow of LPG to the engine.

FIGS. 14 and 15 show schematic cross-sectional views of two particular embodiments of the tank 48 according to the invention, in which the connection means 6 are respectively positioned at the top and the bottom of the tank 48. The sensor 2 represented in FIG. 15 has, according to one particular embodiment, two reference pairs 16, one in the distal part 12 and the other in the proximal part 8.

The tank 48 represented in FIGS. 14 and 15 is drawn schematically without supply and/or discharge or suction ducts, for simplification. It will be clear to a person skilled in the art that these ducts are necessary for the proper functioning of the tank 48 according to the invention.

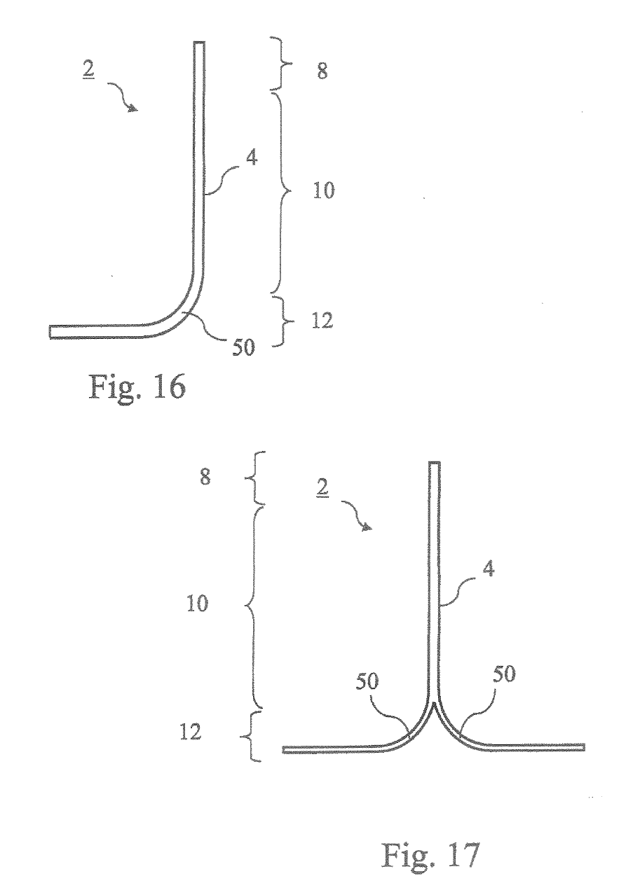

FIG. 16 shows a schematic side view of one particular embodiment of the sensor 2 according to the invention, in which the support 4 has a bend 50 so that the reference pair 16 is positioned horizontally in the bottom of the tank 48. The use of a sufficiently thin support 4 makes it possible to bend this support so as to obtain an L-shape. This particular embodiment makes it possible to measure the level 52 of the liquid 54 practically to the bottom of the tank 48 and with a very high accuracy. The support 4 may, by way of example, be manufactured with a thickness of less than 400 micrometres.

A T-shaped arrangement as shown in FIG. 17 is also possible. The electrodes therein are positioned on both sides of the support 4 and the support 4 advantageously includes a plurality of insulating layers, so as to easily produce a T-shaped division with two bends 50.

Another advantage of the particular embodiments represented in FIGS. 16 and 17 is the possibility of detecting, in the case of a tank 48 holding fuel, the presence in the fuels of water for example, so as to warn the driver and not damage the engine.

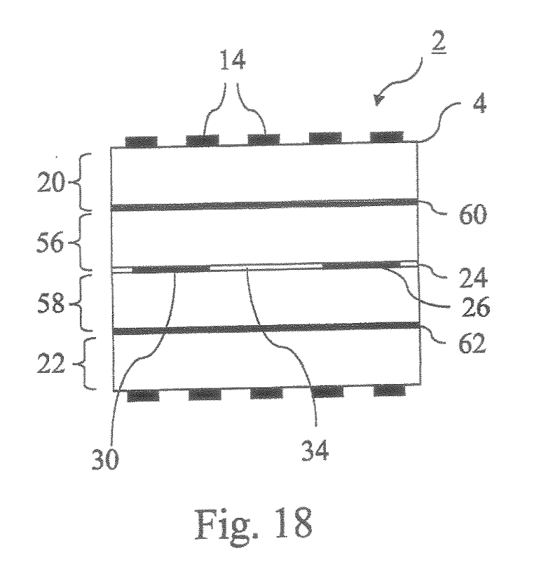

FIG. 18 shows a schematic cross-sectional representation of one particular alternative embodiment of the sensor 2 according to the invention. The support 4 has seven successive layers: a first insulating layer 20 on which the arms of the electrodes are positioned, a sixth conductive layer 60 composed of an earth plane, a fourth insulating layer 56, the inner layer in particular comprising the connection line 26 and an additional line 30, a fifth insulating layer 58, a seventh conductive layer 62 also composed of an earth plane and a second insulating layer 22 on which other aims of the electrodes are positioned.

The following data were observed for this particular embodiment:
C_{ref0}=4.017 pF
C_{ref, 0%}=6.266 pF
C_{ref, 100%}=6.290 pF
C_{ref, 0%}-C_{ref0}=2249 pF
C_{ref, 100%}%-C_{ref, 0%}=0.024 pF
Cₘₑₛ₀=8189 pF=C_{mes, 0%}
C_{mes, 100%}=133.43 pF
C_{mes, 100%}-Cₘₑₛ₀=49.5 pF
   where C_{ref0} is the capacitance of the reference pair 16 when the tank 48 is completely empty, C_{ref, 0}% is the capacitance of the reference pair 16 when it is submerged but when the level 52 is equal to 0, C_{ref, 100%} is the capacitance of the reference pair 16 when the tank 48 is full, Cₘₑₛ₀ is the capacitance of the measurement pair 14 when it is not submerged and C_{mes, 100%} is the capacitance of the measurement pair 14 when the tank 48 is full. This type of sensor according to the invention gives very satisfactory results and demonstrates the substantial independence of the capacitance of the reference pair 16 relative to the level 52 of the liquid 54. The conductive layers 60 and 62 may for example be copper layers, constituting earth planes.

It will be clear to a person skilled in the art that the sensor 2 within the scope of the invention may be a probe, a detector, a measuring instrument or else a device that makes it possible to detect, with a view to a physical phenomenon, in the form of a signal, for example an electric signal, representing it or forming part of such a system.

In addition, it will be clear to a person skilled in the art that, although the sensor 2 is called a capacitive sensor, possible inductive and/or resistive effects may also play a role, especially at high sampling frequency.

In addition, it will be clear to a person skilled in the art that the sensor 2 is a sensor 2 of level 52, in the meaning of a height or a degree of elevation, that the bottom of the tank 48 may or may not be flat, and that it may be an instrument for measuring a filling volume of a tank 48.

In addition, it will be clear to a person skilled in the art that the liquid 54 may be fuel (for example petrol, diesel, LPG or LNG), or any other liquid, or else granular solids having properties similar to those of a liquid 54 (flow properties), such as grains from a grain silo, or a sand tank. Similarly, the tank 48 may for example be a tank for an automotive vehicle, for a plane, for a boat or a basin or container.

In addition, it will be clear to a person skilled in the art that the longitudinal and substantially flat support 4 may be a conductive layer, a printed, for example multilayer, circuit, or more generally an electrically insulating substrate. The support 4 may have one or more bends, as long as the surface of the support 4 is locally flat. According to one embodiment, the electrodes are drawn on the support 4 by photolithography.

In addition, a person skilled in the art will recognize that the connection means constitute the supply of electrical energy and in particular of voltage for the transmission of a signal.

The interdigitated, preferably parallel, arms are interleaved or interdigitated combs, so as to increase the detection area and the sensitivity, or in other words have parallel teeth.

The protective layer 36 of the electrodes may be composed of a lacquer. By its judicial choice, it is possible to modify the wetting angles of the liquids relative to the surface of the support 4 and to optimize the flow of the liquid 54 along this support. Any suitable means for converting the superficial part of the electrodes, such as the surface treatment, for example, by controlled oxidation, may also be used.

The present invention is not limited by that which is in particular illustrated in the drawings and by that which is in particular described above. The references in the claims do not limit the extent of the protection.

1. A capacitive sensor for the level of a liquid in a tank, including:
a longitudinal and substantially flat support, intended to be placed in the tank, the support including:
a proximal part, a central part, and a distal part; and
connection means, located in the proximal part, to electrically connect the support and the outside of the support;
a first pair of electrodes, known as a measurement pair, including arms that are interdigital and placed on the support at least in its central part; and
a second pair of electrodes, known as a reference pair, including arms that are interdigital and placed on the support in its distal part;
wherein:
the support includes at least three layers; and
the reference pair is linked to at least one connection line located in an inner layer of the support and linked to the connection means.

2. The sensor according to claim 1, in which the at least three layers of the support include:
a first insulating layer on which the measurement pair and reference pair are placed;
a second insulating layer; and
the inner layer, located between the first insulating layer and the second insulating layer.

3. The sensor according to claim 2, in which the at least three layers of the support additionally include:
a fourth insulating layer and a fifth insulating layer, located on both sides of the inner layer; and
a sixth conductive layer and a seventh conductive layer intended to be earthed and respectively located between the fourth insulating layer and the first insulating layer and between the fifth insulating layer and the second insulating layer.

4. The sensor according to claim 1, in which the arms of the measurement pair are oriented along the length direction of the support.

5. The sensor according to claim 1, in which the adjacent arms of the reference pair are separated from one another by a smaller distance than that separating the adjacent arms of the measurement pair from one another.

6. The sensor according to claim 1, including an additional reference pair in the proximal part.

7. The sensor according to claim 1, in which the distal part is wider than the central part.

8. The sensor according to claim 7, in which:
the measurement pair is placed at least in the central and distal parts; and
the reference pair is placed on both sides of the measurement pair.

9. The sensor according to claim 1, in which the inner layer includes at least one earth line, separated from the connection line by a first dielectric, intended to form an additional capacitance so as to compensate, at least partially, for variations in the dielectric constant of the materials forming the support.

10. The sensor according to claim 1,
in which the arms of the measurement pair are covered with a protective layer; and
in which the inner layer includes an additional line parallel to the connection line and separated from the connection line by a second dielectric of a similar type to that used for the protective layer, intended to form an additional capacitance so as to compensate, at least partially, for variations in the dielectric constant of the materials forming the protective layer.

11. A tank including a sensor according to claim 1.
